(19) United States
(12) Patent Application Publication
(10) Pub. No.: US 2025/0225475 A1
(43) Pub. Date: Jul. 10, 2025

(54) SYSTEMS AND METHODS FOR UNCONSTRAINED DEMAND FORECAST BASED ON ACCURATE LOST SALES ESTIMATION

(71) Applicant: Walmart Apollo, LLC, Bentonville, AR (US)

(72) Inventor: Fiona Chehong Yeung, San Francisco, CA (US)

(21) Appl. No.: 18/405,139

(22) Filed: Jan. 5, 2024

(51) Int. Cl. G06Q 10/087; G06Q 10/0637; G06Q 30/0202

(52) U.S. Cl. CPC G06Q 10/087; G06Q 10/06375; G06Q 30/0202

(57) ABSTRACT

Systems and methods for enabling unconstrained demand forecast based on accurate lost sales estimation using collective consumer behavior are disclosed. In some embodiments, a disclosed method includes: obtaining raw sales data of an item in a store for a past time period, wherein the item is offered for sale in the store; detecting at least one out-of-stock (OOS) time period within the past time period based on the raw sales data, wherein sale of the item is impacted by an OOS status of the item in the store in the at least one OOS time period; computing, based on a non-linear model, lost sales estimate of the item in the store for each of the at least one OOS time period; generating, based on the raw sales data and the lost sales estimate, recommended inventory for the item in the store for a future time period; and transmitting the recommended inventory to a computing device associated with the store for inventory arrangement in the future time period.

### TECHNICAL FIELD

This application relates generally to demand forecast and, more particularly, to systems and methods for enabling unconstrained demand forecast based on accurate lost sales estimation using collective consumer behavior.

### BACKGROUND

Lost sales are not only a direct cause in loss of revenue, but also an important input for making business decisions that consider market growth opportunities and supply chain planning. Improving on-shelf availability has been recognized as a priority for retailers for decades, yet there is no common consensus in the industry on how best to solve the problem. While some organizations prefer continuously monitoring for out-of-shelf situations and send alerts to store management, others focus on improving the forecast accuracy so that the right amount of inventory can be shipped to the right place at the right time.

Most forecasting systems only provide constrained forecasts, which are based on actual sales that were limited by operational capacity of the business such as shelf space, inventory holding capacity, availability of labor, and suppliers' backlog. Instead, unconstrained demand forecasts that include the unachieved demand potential are desired because they represent the customer's true demand that is not limited by the operational capacity of the business. With only partially observed demand in historical data, the constrained forecast tends to drop if an item goes out of stock for an extended period, as it cannot distinguish whether the reduced sales are due to genuine waning demand or lack of on-shelf availability. This creates a cycle of self-fulfilling prophecy of downward sales due to self-induced inadequate replenishment, which currently needs human operators to discover such forecasting error and lift the forecast manually such that the inventory can be replenished properly once again.

### SUMMARY

The embodiments described herein are directed to systems and methods for enabling unconstrained demand forecasts based on accurate lost sales estimation using collective consumer behavior.

In various embodiments, a system including a non-transitory memory configured to store instructions thereon and at least one processor is disclosed. The at least one processor is operatively coupled to the non-transitory memory and configured to read the instructions to: obtain raw sale data of an item in a store for a past time period, wherein the item is offered for sale in the store; detect at least one out-of-stock (OOS) time period within the past time period based on the raw sales data, wherein sale of the item is impacted by an OOS status of the item in the store in the at least one OOS time period; compute, based on a non-linear model, lost sales estimate of the item in the store for each of the at least one OOS time period; generate, based on the raw sales data and the lost sales estimate, recommended inventory for the item in the store for a future time period; and transmit the recommended inventory to a computing device associated with the store for inventory arrangement in the future time period.

In various embodiments, a computer-implemented method is disclosed. The computer-implemented method includes: obtaining raw sales data of an item in a store for a past time period, wherein the item is offered for sale in the store; detecting at least one out-of-stock (OOS) time period within the past time period based on the raw sales data, wherein sale of the item is impacted by an OOS status of the item in the store in the at least one OOS time period; computing, based on a non-linear model, lost sales estimate of the item in the store for each of the at least one OOS time period; generating, based on the raw sales data and the lost sales estimate, recommended inventory for the item in the store for a future time period; and transmitting the recommended inventory to a computing device associated with the store for inventory arrangement in the future time period.

In various embodiments, a non-transitory computer readable medium having instructions stored thereon is disclosed. The instructions, when executed by at least one processor, cause at least one device to perform operations including: obtaining raw sales data of an item in a store for a past time period, wherein the item is offered for sale in the store; detecting at least one out-of-stock (OOS) time period within the past time period based on the raw sales data, wherein sale of the item is impacted by an OOS status of the item in the store in the at least one OOS time period; computing, based on a non-linear model, lost sales estimate of the item in the store for each of the at least one OOS time period; generating, based on the raw sales data and the lost sales estimate, recommended inventory for the item in the store for a future time period; and transmitting the recommended inventory to a computing device associated with the store for inventory arrangement in the future time period.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for forecasting consumer demand based on accurate lost sales estimation, in accordance with some embodiments of the present teaching;

FIG. 2 is a block diagram of a demand forecast computing device, in accordance with some embodiments of the present teaching;

FIG. 3 is a block diagram illustrating various portions of a system for forecasting consumer demand based on accurate lost sales estimation, in accordance with some embodiments of the present teaching;

FIG. 4 illustrates a process for predicting consumer demand, in accordance with some embodiments of the present teaching;

FIG. 5 illustrates a process for detecting out-of-stock (OOS) time periods based on inventory data, in accordance with some embodiments of the present teaching;

FIG. 6 illustrates a process for detecting OOS time periods based on sale anomaly, in accordance with some embodiments of the present teaching;

FIG. 7 illustrates a process for estimating lost sales, in accordance with some embodiments of the present teaching;

FIG. 8 illustrates an example for fitting a non-learning model based on covariates, in accordance with some embodiments of the present teaching;

FIG. 9 illustrates a process for generating unconstrained sale data, in accordance with some embodiments of the present teaching;

FIG. 10 is a flowchart illustrating an exemplary method for forecasting consumer demand based on accurate lost sales estimation, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Estimating unfulfilled demand potential, or lost sales, is a difficult problem because it involves estimating sales that would otherwise have occurred if the item had been available on the shelf. Lost sales are counterfactual and thus cannot be measured directly. For e-Commerce setting, an online retailer can log the desired purchase quantity that the customers entered from the website but cannot be fulfilled. But for physical store setting, the retailer cannot exactly know how many more items a customer would have bought had it been made available at that time. The present teaching aims to bridge this gap by estimating the lost sales incurred at the item-store level, even if there is no customer backlog captured. Once lost sales are estimated, it can then be added to the partially observed demand to reflect the consumer intention at large, thereby providing a more accurate unconstrained input to any downstream forecasting system, e.g. inventory planning.

One common approach to lost sales estimation includes using substitutable items as proxies, calculating a moving average of the item's sales quantity over time, and identifying trending items by human knowledge. But there is no definitive way of determining item substitutability, especially given a big retailer's diverse universe of items. In addition, a moving average estimate would lead to erroneous results for seasonal items and event-driven sales because computing moving average only considers lagged data. Furthermore, human operators require ample amount of time to gain intuition and expert knowledge on sales pattern of just a small set of items and therefore is not a scalable solution.

Instead of using proxies, lagged sales data, or relying on human intervention, the present teaching discloses a scalable data-driven method to estimate the lost sales using relevant stores, if available, in a retailer's geographically diverse store network, and automatically complete the partially observed sales data before being consumed by the forecasting algorithms. In other words, the disclosed method attempts to make whole the incomplete sales data such that the true consumer demand is reflected in the input data for any downstream forecasting algorithm. This will turn any constrained forecasting system into an unconstrained forecasting system.

In some embodiments, a disclosed system uses a machine-learning based method to estimate lost sales by leveraging data from an extensive store network of a retailer. A generalized additive model (GAM) is disclosed to capture consumer behavior across diverse geolocations of the store network and infer any lost sales incurred at each store using data available at the other stores. As such, consumer intents at large can be better understood than using historical data from a single store alone.

In some embodiments, the disclosed method leverages the collective consumer pattern from the entire store network across diverse geolocations to better infer the true consumer intent at a single store. The feature attributes that are used include: e.g. all stores' historical sales, consumer calendar for national holidays and local events, and the latitude and longitude of the store locations for inference on weather related trends.

In some embodiments, the disclosed system estimates lost sales of an item in a local store of a retailer, while the retailer has no other store or no sale of the item in any other store. In this situation, the GAM model can still be used to infer any lost sales of the item in the local store based on various feature attributes, including: e.g. the local store's historical sales, consumer calendar for national holidays and local events, location of the local store for inference on local weather related trends, etc.

In some embodiments, the disclosed system provides unconstrained forecasts by automatically augmenting the observed sales with the estimated lost sales as a combined input to any forecasting algorithm, e.g. to forecast true consumer demand for an item in a store during next week, to determine an inventory arrangement for an item in a store during next month, to predict revenue from a store next year, etc.

Furthermore, in the following, various embodiments are described with respect to systems and methods for enabling unconstrained demand forecast based on accurate lost sales estimation are disclosed. In some embodiments, a disclosed method includes: obtaining raw sales data of an item in a store for a past time period, wherein the item is offered for sale in the store; detecting at least one out-of-stock (OOS) time period within the past time period based on the raw sales data, wherein sale of the item is impacted by an OOS status of the item in the store in the at least one OOS time period; computing, based on a non-linear model, lost sales estimate of the item in the store for each of the at least one OOS time period; generating, based on the raw sales data and the lost sales estimate, recommended inventory for the item in the store for a future time period; and transmitting the recommended inventory to a computing device associated with the store for inventory arrangement in the future time period.

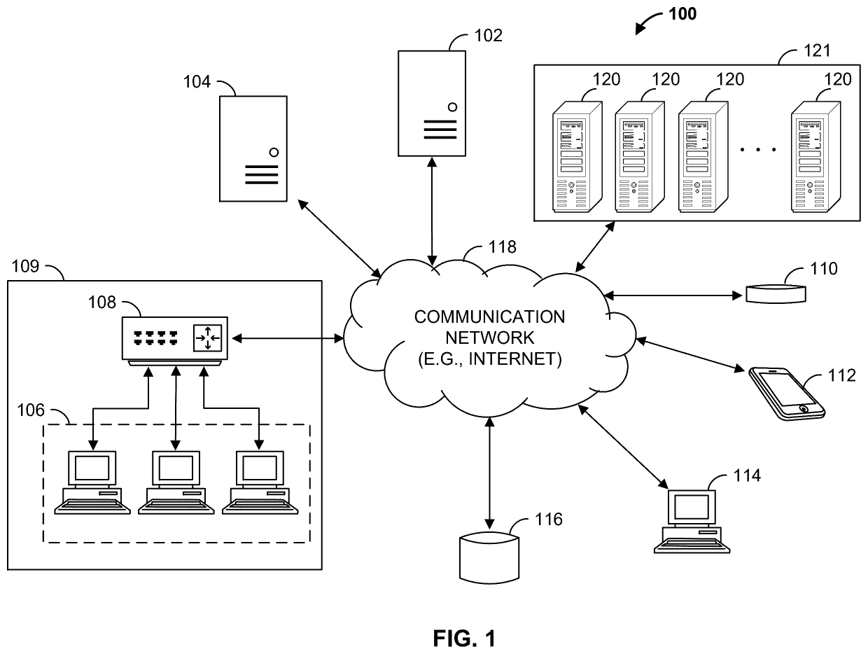

Turning to the drawings, FIG. 1 is a network environment 100 configured for forecasting consumer demand based on accurate lost sales estimation, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a demand forecast computing device 102, a server 104 (e.g., a web server or an application server), a cloud-based engine 121 including one or more processing devices 120, a database 116, and one or more customer computing devices 110, 112, 114 operatively coupled over the network 118. The demand forecast computing device 102, the server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the demand forecast computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the demand forecast computing device 102.

In some examples, each of the multiple customer computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more retailer websites. In some examples, the demand forecast computing device 102, the processing devices 120, and/or the server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the demand forecast computing device 102 over the communication network 118. The workstation(s) 106 may send data to, and receive data from, the demand forecast computing device 102. For example, the workstation(s) 106 may transmit data identifying items purchased by a customer at the store 109 to the demand forecast computing device 102.

Although FIG. 1 illustrates three customer computing devices 110, 112, 114, the network environment 100 can include any number of customer computing devices 110, 112, 114. Similarly, the network environment 100 can include any number of the demand forecast computing devices 102, the processing devices 120, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first customer computing device 110, the second customer computing device 112, and the Nth customer computing device 114 may communicate with the server 104 over the communication network 118. For example, each of the multiple customer computing devices 110, 112, 114 may be operable to view, access, and interact with a website, such as a retailer's website, hosted by the server 104. The server 104 may transmit user session data related to a customer's activity (e.g., interactions) on the website. For example, a customer may operate one of customer computing devices 110, 112, 114 to initiate a web browser that is directed to the website hosted by the server 104. The customer may, via the web browser, view item advertisements for items displayed on the website, and may click on item advertisements, for example. The website may capture these activities as user session data, and transmit the user session data to the demand forecast computing device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the demand forecast computing device 102.

In some examples, the store 109 may transmit a request to the demand forecast computing device 102. The request may be sent standalone or together with store related data of the store 109. In some examples, the request may seek advice on: e.g. consumer demand estimation for an item in a future period, inventory planning for items in a future period, and some business decisions regarding items offered for sale in the store 109.

In some embodiments, the store 109 can be replaced by a distribution center, a fulfillment center, or any type of warehouse for replenishment purposes, without impacting the functions of the other components in the disclosed system. In some embodiments, the store 109 can be replaced by a vendor or manufacturer or an automatic ordering system requesting a forecast, without impacting the functions of the other components in the disclosed system.

In some examples, the demand forecast computing device 102 may execute one or more models (e.g., programs or algorithms), such as a machine learning model, deep learning model, statistical model, etc., to compute an estimated consumer demand for an item offered for sale in the store 109 during a future time period, e.g. next week, next month or next year. The demand forecast computing device 102 may generate and transmit recommended inventory data based on the estimated in-store demands to the store 109 over the communication network 118, and the store 109 may refresh its inventory according to the recommended inventory data.

The demand forecast computing device 102 is further operable to communicate with the database 116 over the communication network 118. For example, the demand forecast computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the demand forecast computing device 102, in some examples, the database 116 can be a local storage device, such as a hard drive, a non-volatile memory, or a USB stick. The demand forecast computing device 102 may store purchase data received from the server 104 in the database 116. The demand forecast computing device 102 may receive store related data from different stores 109 and store them as store data in the database 116. The demand forecast computing device 102 may also receive from the server 104 user session data identifying events associated with browsing sessions, and may store the user session data in the database 116.

In some examples, the demand forecast computing device 102 generates and/or updates different models for estimating consumer demand based on estimated lost sales data. The models, when executed by the demand forecast computing device 102, allow the demand forecast computing device 102 to determine consumer demands and generate recommended inventory data for each store to refresh inventory for a future time period.

In some examples, the demand forecast computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the demand forecast computing device 102 may generate recommended inventory data.

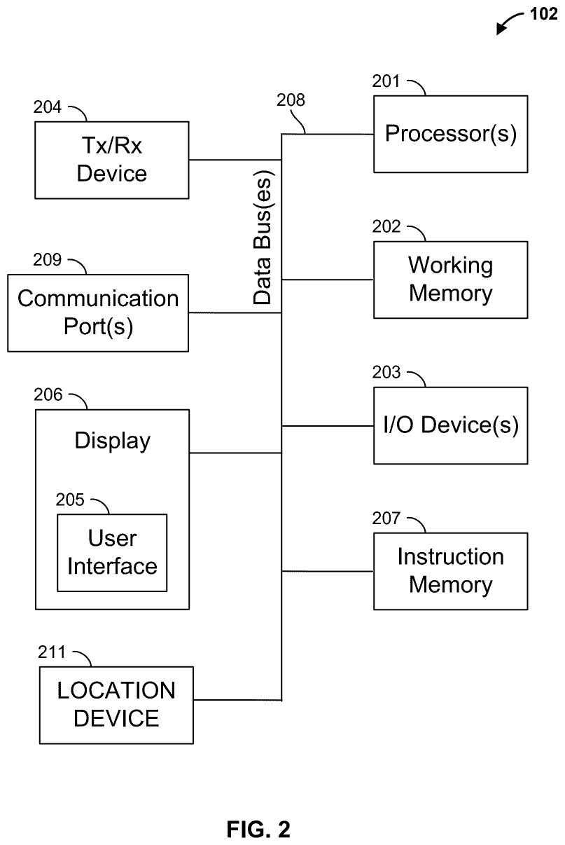

FIG. 2 illustrates a block diagram of a demand forecast computing device, e.g. the demand forecast computing device 102 of FIG. 1, in accordance with some embodiments of the present teaching. In some embodiments, each of the demand forecast computing device 102, the server 104, the multiple customer computing devices 110, 112, 114, and the one or more processing devices 120 in FIG. 1 may include the features shown in FIG. 2. Although FIG. 2 is described with respect to certain components shown therein, it will be appreciated that the elements of the demand forecast computing device 102 can be combined, omitted, and/or replicated. In addition, it will be appreciated that additional elements other than those illustrated in FIG. 2 can be added to the demand forecast computing device 102.

As shown in FIG. 2, the demand forecast computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the demand forecast computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the demand forecast computing device 102 can include a single memory unit configured to operate as both instruction memory and working memory. Further, although embodiments are discussed herein including non-volatile memory, it will be appreciated that the demand forecast computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the demand forecast computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the demand forecast computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the demand forecast computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T−1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the demand forecast computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the demand forecast computing device 102 may determine a local geographical area (e.g., town, city, state, etc.) of its position.

In some embodiments, the demand forecast computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

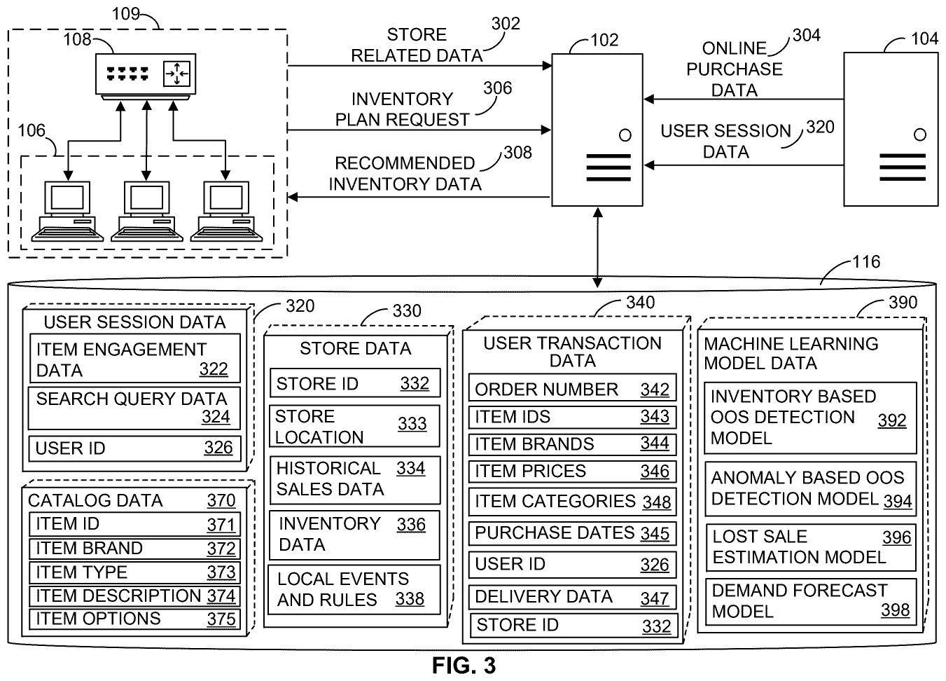

FIG. 3 is a block diagram illustrating various portions of a system for forecasting consumer demand based on accurate lost sales estimation, e.g. the system shown in the network environment 100 of FIG. 1, in accordance with some embodiments of the present teaching. As indicated in FIG. 3, the demand forecast computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 322, search query data 324, and user ID 326 (e.g., a customer ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search query data 324 may identify one or more searches conducted by a user during a browsing session (e.g., a current browsing session). The demand forecast computing device 102 may also receive online purchase data 304 from the web server 104, which identifies and characterizes one or more online purchases, such as purchases made by the user and other users via a retailer's website hosted by the web server 104.

The demand forecast computing device 102 may also receive store related data 302 from the store 109, which identifies and characterizes one or more in-store purchases. In some embodiments, the store related data 302 may also indicate other information about the store 109. The demand forecast computing device 102 may parse the store related data 302 to generate store data 330. In this example, the store data 330 may include, for each store, one or more of: a store ID 332 of the store, a store location 333 of the store, a historical sales data 334 indicating historical sales for each displayed item in the store, an inventory data 336 identifying and charactering an inventory status for each item being displayed in the store, and local events and rules 338 indicating information related to events, holidays, and government rules that are local to the store.

The demand forecast computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (e.g., category) of each item purchased, purchase dates 345 identifying the purchase dates of the purchase orders, a user ID 326 for the user making the corresponding purchase, delivery data 347 indicating delivery information for corresponding online orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store machine learning model data 390 identifying and characterizing one or more machine learning models and related data. For example, the machine learning model data 390 may include an inventory based OOS detection model 392, an anomaly based OOS detection model 394, a lost sales estimation model 396, and a demand forecast model 398. The inventory based OOS detection model 392 may be used to detect OOS time periods for an item in a store based on an inventory status of the item. For example, the inventory based OOS detection model 392 may detect the OOS time periods by determining when (1) there is no on-hand inventory left for the item, or (2) there is less than one day of supply (DOS) on-hand and there is no sale for the item. The intent of the second condition is to avoid counting phantom stock (due to theft, damaged goods, etc.) as on-hand inventory. A safety stock is usually kept at more than one DOS to cover any forecast error.

The anomaly based OOS detection model 394 may be used to detect OOS time periods for an item in a store based on sale anomaly of the item. For example, the inventory based OOS detection model 392 may detect the OOS time periods by determining when there is a sale anomaly, e.g. a sudden sale number drop, with respect to a baseline established by weeks that appear to be in-stock. In some embodiments, the baseline is determined based on historical sales data of the same item in the same store. In some embodiments, the baseline is determined based on historical sales data of the same item in all physical stores of the retailer. In some embodiments, the baseline is determined based on historical sales data of the same item in all physical stores and online stores of the retailer.

The lost sales estimation model 396 may be used to compute estimated lost sales data of an item in a store. For example, based on the lost sales estimation model 396, in-stock only sales data for the item is first generated by excluding OOS time periods from the raw sales data of the item. Then, a model fitting or training may be performed using covariates related to sale of the item as an input, and using imputed daily sale as a target response variable. The estimated lost sales of the item can be determined by subtracting actual sale data from the imputed sale data in each OOS time period.

The demand forecast model 398 may be used to compute an estimated consumer demand for an item in a store during a future time period, e.g. based on the estimated lost sales data. In some examples, the demand forecast model 398 may be used to add the estimated lost sales data for each OOS time period to the raw sale data to generate unconstrained sale data of the item. Using the unconstrained sale data, the demand forecast model 398 may predict an unconstrained consumer demand for the item in the store for the future time period. In some embodiments, each of the models in the machine learning model data 390 is updated weekly.

In some examples, the demand forecast computing device 102 receives an inventory plan request 306 from the store 109. The inventory plan request 306 may be associated with a request for recommended inventory arrangement for products offered for sale in the store 109 in a future time period. For example, a retailer may be associated with a plurality of physical stores (including the store 109) for selling products in-store. The inventory plan request 306 is to seek a recommendation on an inventory stock level planned for an item in the store 109 for the future time period. In response, the demand forecast computing device 102 may obtain raw sales data of the item from the store 109 and from other physical stores during a past time period. The demand forecast computing device 102 may detect one or more OOS time periods, e.g. OOS weeks, during the past time period. In each OOS week, sale of the item in the store 109 is impacted by an OOS status of the item in the store 109. In some embodiments, the OOS detection may be performed based on both the inventory based OOS detection model 392 and the anomaly based OOS detection model 394. In some embodiments, a week is determined to be an OOS week so long as one of the inventory based OOS detection model 392 and the anomaly based OOS detection model 394 detects OOS status for the item. In some embodiments, the demand forecast computing device 102 excludes the OOS weeks from the raw sales data, and compute lost sales data of the item in the store 109 for each OOS week based on a non-linear model, e.g. the lost sales estimation model 396. In some embodiments, the demand forecast computing device 102 may generate, based on the raw sale data and the lost sales data, recommended inventory data 308 for the store 109 in the future time period.

In some embodiments, the demand forecast computing device 102 may assign one or more of the above described operations to a different processing unit or virtual machine hosted by one or more processing devices 120. Further, the demand forecast computing device 102 may transmit the recommended inventory data 308 to the store 109 in response to the inventory plan request 306.

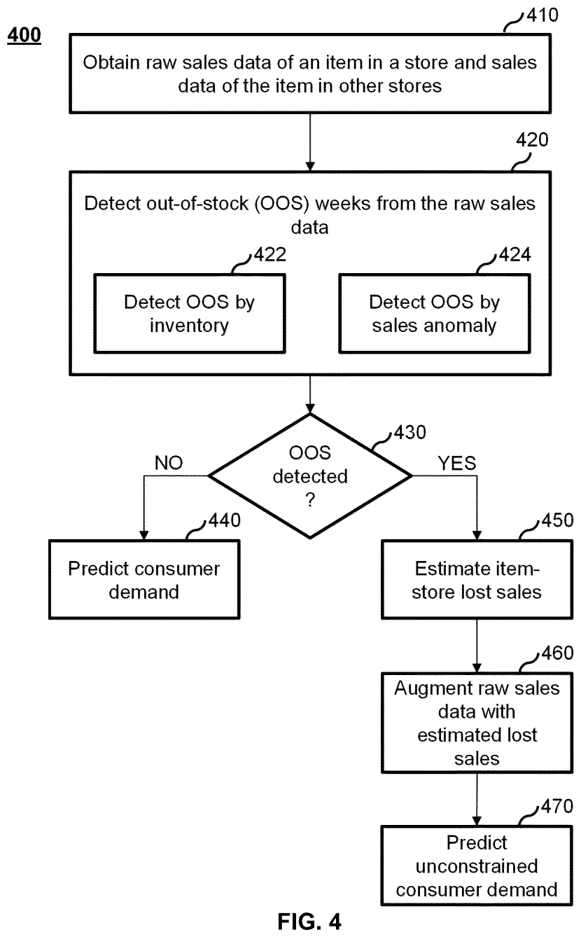

FIG. 4 illustrates a process 400 for predicting consumer demand, in accordance with some embodiments of the present teaching. In some embodiments, the process 400 can be carried out by one or more computing devices, such as the demand forecast computing device 102 and/or the cloud-based engine 121 of FIG. 1. As shown in FIG. 4, the process 400 starts from operation 410, where raw sales data of an item in a store is obtained, together with sales data of the same item in at least one other store. In some embodiments, all sales data are from a same past time period, e.g. past month, past year, or past multiple years. In some embodiments, the store and the at least one other store include all physical stores associated with a same retailer. In some embodiments, the store is a physical store associated with a retailer; and the at least one other store includes an online store associated with the retailer. In some embodiments, the store refers to a geolocation area (e.g. one zip code) where all online shopping of an item is delivered to; and the at least one other store includes other geolocation areas (e.g. other zip codes) where all online shopping of the item is delivered to.

At operation 420, out-of-stock (OOS) time periods, e.g. OOS weeks, are detected within the past time period from the raw sales data. Sale of the item is impacted by an OOS status of the item in the store in each OOS week.

In some embodiments, the operation 420 includes a sub-operation 422 and/or a sub-operation 424. At sub-operation 422, each OOS week is detected based on an inventory status of the item. At sub-operation 424, each OOS week is detected based on sales anomaly of the item. In some embodiments, the sales anomaly is determined based on historical sales data of the item and the inventory status of the item. In some embodiments, a week in the past time period is determined to be an OOS week, in accordance with a determination that the week is detected as OOS in at least one of the sub-operation 422 or the sub-operation 424.

At operation 430, it is determined whether any OOS time period, e.g. OOS week, is detected for the item in the store within the past time period. If not, the process 400 goes to operation 440, where a consumer demand is predicted. At operation 440, since there is no OOS detected for the item, the consumer demand can be predicted based on any prediction method for constrained consumer demand, e.g. based on a moving average of the item's sales quantity over time. Accordingly, recommended inventory data may be generated based on the predicted consumer demand, and transmitted to the store for inventory arrangement in the future time period.

When it is determined at the operation 430 that at least one OOS time period, e.g. OOS week, is detected for the item in the store within the past time period, the process 400 goes to operation 450, where lost sales data of the item in the store for each OOS time period is estimated, e.g. based on a non-linear model and sale data of the item in the at least one other store.

At operation 460, the raw sales data of the item is augmented with the estimated lost sales data of the item. This generates an unconstrained sale data of the item for the past time period.

At operation 470, an unconstrained consumer demand is predicted for the item in the store for the future time period, based on the unconstrained sale data. Accordingly, recommended inventory data may be generated based on the unconstrained demand, and transmitted to the store for inventory arrangement in the future time period.

As such, the process 400 provides an out-of-stock detection method (as performed in the operation 420) that does not require cameras or any continuous monitoring, thereby avoiding any privacy concerns. In addition, the process 400 provides a scalable data-driven lost sales estimation method (as performed in the operation 450) that leverages the collective consumer pattern from a retailer's geographically diverse store network. Further, the process 400 enables a constrained forecasting system to forecast unconstrained demand by automatically augmenting the observed sales with the estimated lost sales.

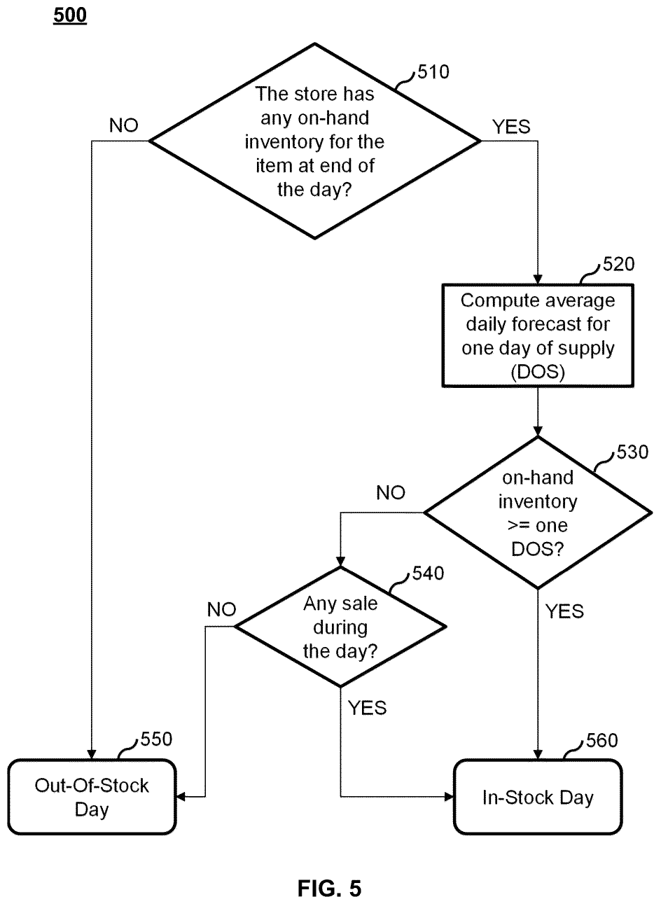

In some embodiments, lost sales can only happen when the item is not available for purchase. As such, the first concern for lost sales estimation is to determine the weeks that were OOS. FIG. 5 illustrates a process 500 for detecting out-of-stock (OOS) time periods based on inventory data, in accordance with some embodiments of the present teaching. In some embodiments, the process 500 can be carried out by one or more computing devices, such as the demand forecast computing device 102 and/or the cloud-based engine 121 of FIG. 1. In some embodiments, the process 500 is implemented to perform the operation 422 in FIG. 4, to determine whether a given week is an OOS week or an IS week for an item in a store.

In the example of process 500, OOS is detected on a day level. That is, the purpose of the process 500 is to determine whether each day in the past time period is an out-of-stock (OOS) day or an in-stock (IS) day for the item in the store. In some embodiments, if at least one day in a week is OOS, the week is considered OOS, which means lost sales might have occurred during that week.

As shown in FIG. 5, the process 500 starts from operation 510, where it is determined, given an item, a store and a day, whether the store has any on-hand inventory for the item at end of the day. If it is determined at the operation 510 that there is no on-hand inventory left for the item at end of the day, this is a direct indication of OOS. As such, the process 500 goes directly to operation 550 to identify the day as an OOS day for the item in the store.

On the other hand, if it is determined at the operation 510 that the store has some on-hand inventory left for the item at end of the day, the process 500 goes to operation 520, where an average daily forecast is computed for one day of supply (DOS) for the item. In some embodiments, safety stock is usually kept at more than one DOS to cover any forecast error. Accordingly, one DOS is used as a threshold at operation 530 to determine whether the on-hand inventory for the item at end of the day is larger than or equal to the one DOS threshold. If so, the process 500 goes directly to operation 560 to identify the day as an IS day for the item in the store.

On the other hand, if it is determined at the operation 530 that the on-hand inventory for the item at end of the day is less than the one DOS threshold, the process 500 goes to operation 540, where it is determined whether the store has any sale of the item during the day. If so, the process 500 goes to operation 560 to identify the day as an IS day for the item in the store. If not, the process 500 goes to operation 550 to identify the day as an OOS day for the item in the store.

In some embodiments, the past time period is divided into one or more weeks. As discussed above, the process 500 shows a decision logic for using item-store inventory to detect OOS for any given day of a given week. For each week of the past time period, the week can be determined as an OOS week in accordance with a determination that at least one day of the week is determined as an OOS day, according to the process 500.

In many cases, detecting OOS from the inventory status alone is not adequate. Inventory discrepancy is a prevalent problem in the industry. It can be caused by multiple factors such as warehouse receiving errors, misplaced inventory, and phantom stock where items on-hand are not in sellable condition. In addition, the shelves may be empty, but inventory is available in the backroom. Therefore, OOS may be undetected if the system only relies on an inventory scan. To this end, a novel complementary method is disclosed based on the spectral residual algorithm. This method works by finding anomalies from the sales data that are outliers with respect to a baseline established by weeks that appear to be in-stock.

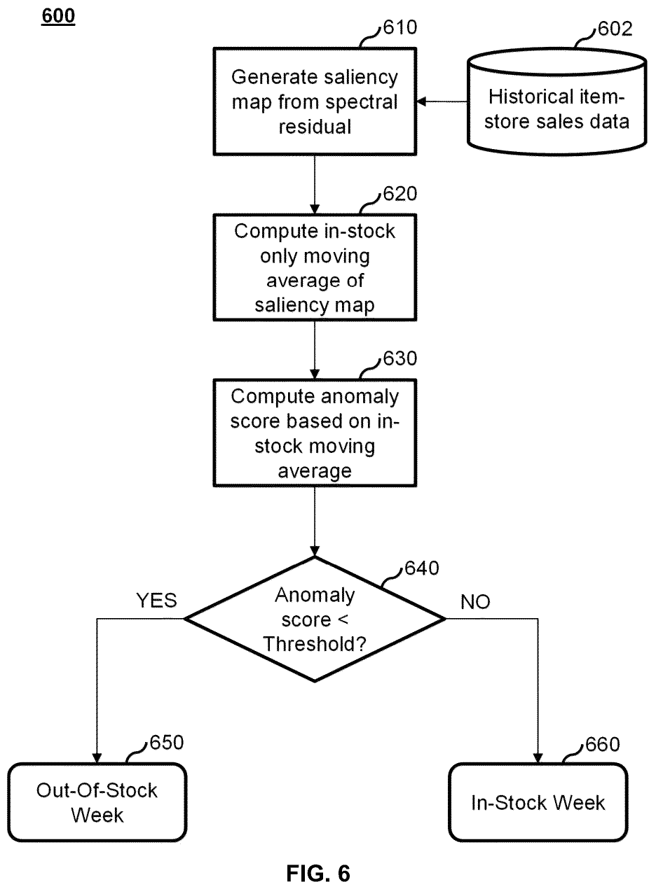

FIG. 6 illustrates such an OOS detection process 600 for detecting OOS time periods based on sale anomaly, in accordance with some embodiments of the present teaching. In some embodiments, the process 600 finds abnormal sales pattern at the item-store level using a customized version of a spectral residual algorithm.

In some embodiments, the process 600 can be carried out by one or more computing devices, such as the demand forecast computing device 102 and/or the cloud-based engine 121 of FIG. 1. In some embodiments, the process 600 is implemented to perform the operation 424 in FIG. 4, to determine whether a given week is an OOS week or an IS week for an item in a store.

As shown in FIG. 6, the process 600 starts from operation 610, where a saliency map of the item is generated using a spectral residual method, e.g. based on the inventory status and the historical sales data of the item in the store. In some embodiments, the historical sales data is obtained from a database 602, which stores historical item-store level sales data for all stores associated with a retailer. In some embodiments, the database 602 is part of the database 116 or a standalone database. In some embodiments, the database 602 includes the historical sales data 334 in the database 116.

At operation 620, an in-stock moving average of the saliency map is computed. In some embodiments, the in-stock moving average is computed based on sales data of the item when the item is in-stock in the store. In some embodiments, the in-stock moving average indicates a moving average of weekly or daily sales data of the item when the item is in-stock in the store. In some embodiments, the in-stock moving average establishes a baseline for determining a sale anomaly or sale outlier for the item.

At operation 630, an anomaly score is computed for the given week based on the in-stock moving average. In some embodiments, the anomaly score indicates a difference between the actual sales quantity of the item and the in-stock moving average of the item for the week. In some embodiments, the anomaly score is a negative score, where a more negative value indicates a more anomalous sales quantity, i.e. a spike down compared to baseline. In some embodiments, the anomaly score can be either positive or negative, where a more negative value indicates a more anomalous sales quantity.

At operation 640, it is determined whether the anomaly score is below a predetermined threshold. If so, the process 600 goes to operation 650 to identify the week as an OOS week for the item in the store. If not, the process 600 goes to operation 660 to identify the week as an IS week for the item in the store. In some embodiments, the threshold is determined based on historical lost sales estimation results.

In some embodiments, the identification of the in-stock weeks used to establish the baseline does not need to be perfect. In some embodiments, the sales data is first transformed to the frequency domain to amplify the saliency of the outliers before applying a threshold. Therefore, there is a sufficient margin of error that can tolerate the imperfect baseline.

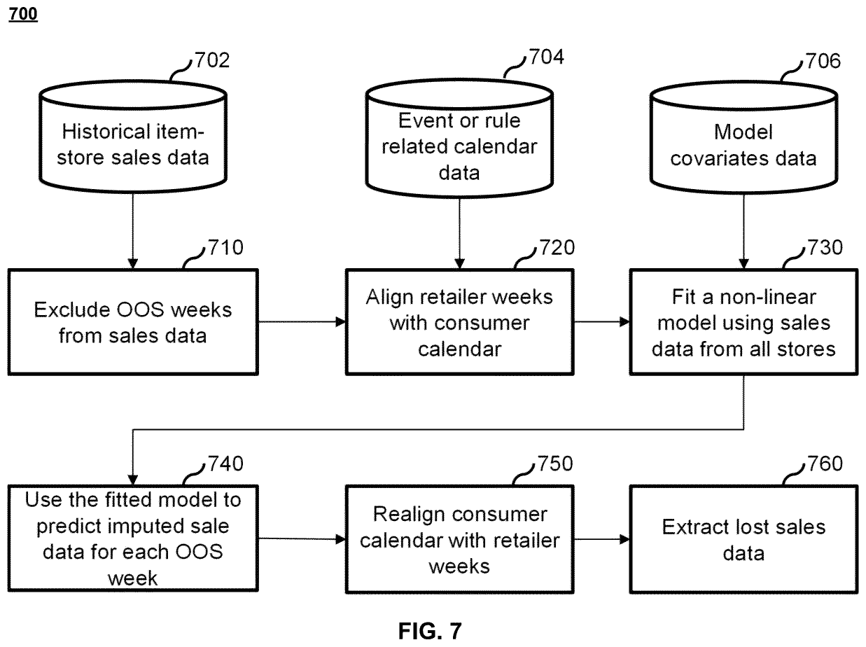

FIG. 7 illustrates a process 700 for estimating lost sales data, in accordance with some embodiments of the present teaching. In some embodiments, the process 700 can be carried out by one or more computing devices, such as the demand forecast computing device 102 and/or the cloud-based engine 121 of FIG. 1. In some embodiments, the process 700 is implemented to perform the operation 450 in FIG. 4, to estimate item-store level lost sales, i.e. lost sales for a given item in a given store.

As shown in FIG. 7, the process 700 starts from operation 710, where the sale data of the item in the store in each OOS time period, e.g. each OOS week, is excluded from sales data from all stores that stock the item. This is to exclude the OOS weeks (e.g. as determined based on the process 500 and/or 600) from the item-store sales record. This removes all partially observed sales data that will be backfilled later with the desired complete sales estimated. The true demand potential will be estimated through imputation by leveraging observed sales from all stores in-stock during those weeks (i.e., the collective consumer behavior observed on the exact weeks, not lagged weeks).

In some embodiments, each OOS week is excluded at the operation 710 from sales data from all stores that stock the item (including raw sales data of the item in the store) to generate IS-only sale data of the item in the stores for the past time period. All IS-only sale data from all stores can be combined as combined sale data.

In some embodiments, the sales data from all stores is obtained at the operation 710 from a database 702, which stores historical item-store level sales data for all stores associated with a retailer. In some embodiments, the database 702 is part of the database 116 or a standalone database. In some embodiments, the database 702 includes the historical sales data 334 in the database 116.

In some embodiments, the raw sales data is in format of retailer weeks, where each retailer week starts at a fixed day (e.g. Saturday) of a calendar week. At the same time, consumer behavior may be related to consumer weeks. In some examples, a first day of a calendar month always aligns with a first day of one of the consumer weeks. For example, a payout day can be set to be a first day of each calendar month, regardless whether it is a Sunday or Monday or any other day in a week. The payout day could trigger a sales spike for some grocery items in some stores. As such, the raw sales data is desired to be preprocessed such that it aligns with the consumer's calendar. Consumer calendars are often specified as the n-th day(s) of a month for different states, which can be a Sunday, Monday, etc. Different states could have different schedule for payout dates. One state may have multiple payout dates in a month, e.g. first and third of each month. These are the days when a spike in demand is anticipated. When a retailer's week regarding OOS detection and demand estimation always starts on a Saturday, it does not necessarily align with the days that higher consumer spending is predicted.

Therefore, at operation 720, the retailer weeks are aligned with the consumer calendar. This can be done by dividing the combined sale data into daily sale data of the item. For example, the system can breakdown the historical sales data in the retailer weeks to daily sales to align with the consumer calendar, in which the first week always starts on the first day of the month and ends on the seventh day of the month. That is, a retailer week can be split across two consecutive calendar weeks. Such calendar alignment is essential in predicting the correct timing of the demand spikes at the week level, especially for items that exhibit cyclical behavior such as those induced by payout dates.

In some embodiments, the consumer calendar data is obtained at the operation 720 from a database 704, which stores event or rule related calendar data, e.g. calendar dates related to local events, holidays, or rules. In some embodiments, the database 704 is part of the database 116 or a standalone database. In some embodiments, the database 704 includes the local events and rules 338 in the database 116.

Then, at operation 730, a non-linear model is fit using sales data from all stores to generate a fitted model, and to compute an average daily sale of the item for each of the consumer weeks or each calendar week. For example, the average daily sales for each calendar week may be a target response variable for the model fitting of the non-linear model, while some covariates are used as input to the non-linear model.

In some embodiments, the covariates are related to sale of the item in the store and the at least one other store for the non-linear model. In some embodiments, the covariates are generated based on the combined sale data, i.e. the IS-only sales data of all stores that sell the item. In some embodiments, the covariates include data related to: week of month, month of year, year, assistance program payout proportion for each local state, latitude and longitude of each store, local consumer patterns of each store, and a quantity of weeks to or after a predefined set of national and local events and holidays.

In some embodiments, the covariates are obtained at the operation 730 from a database 706, which stores various covariates data for the non-linear model. In some embodiments, the database 706 is part of the database 116 or a standalone database. In some embodiments, the database 706 includes various data in the store data 330 in the database 116.

In some embodiments, the non-linear model is a machine learning model trained based on sale data from all stores. In some embodiments, the non-linear model is a generalized additive model (GAM). The GAM may be used to model the nonlinear relationships between the covariates and the response variable and to impute the missing item-store sales data (after excluding the OOS weeks). The interaction terms among the covariates are included and various types of splines and basis functions are used to fit the observed sales data. The output of GAM signifies the degree to which both local and global characteristics have on local consumer demand, which may be reflected by the mean daily item-store sales for each calendar week. This result will be used to impute the complete demand potential of the OOS weeks that were excluded earlier.

In some embodiments, the model fitting at the operation 730 is performed based on all sales data from all stores having the item in stock, e.g. by trying different parameters to minimize error and find optimal parameters. After the model fitting, the fitted model will be applied to each individual store.

At operation 740, the fitted model is used to impute sales of the item in the store for each excluded OOS week. At operation 750, the consumer calendar is re-aligned with the retailer weeks. That is, the imputed sales data is re-assembled to be aligned with the one or more retailer weeks.

At operation 760, lost sales data of the item is extracted for each OOS week by subtracting actual sales data from the imputed sales data in the OOS week. In some embodiments, since the goal is to forecast unconstrained demand from currently constrained forecasting systems, the lost sales are extracted for each OOS week by subtracting the actual sales from the imputed values if the imputed values are higher than the actual sales. Otherwise, no lost sales are assumed.

In some embodiments, the GAM is a middle ground between simple models that do not have enough power to fit complex data but are easy to understand, and black-box neural network-based methods that fit the high dimensional data well but are hard to interpret. GAM is a type of nonparametric regression that does not require strong distributional assumption of the data. Estimation of the model parameters and the nonparametric curve in the model is generally solved by maximizing a penalized likelihood. One main advantage of GAM is its ability to model highly complex nonlinear relationships when the number of potential covariates is large. But the model can be prone to overfitting if regularization is not applied appropriately.

In some embodiments, the disclosed method does not rely on data points that are known to correspond to a lack of on-hand inventory when OOS occurs. Instead, it imputes these data points by using each sales time series' own history, along with other sales time series that are similar in consumer behavior and from comparable store geolocations in latitude and longitude. Consumer calendars, time to and after national holidays, and local events are also used as covariates in the estimation. The unobservable lost sales are then approximated by subtracting the actual sales from the imputed values if the imputed values are higher than the actual sales. Otherwise, no lost sales are assumed.

In some embodiments, during pre-processing, the raw sales data, which is in retailer year-week format, needs to be preprocessed such that it aligns with the consumer calendar.

The historical sales data in retailer year-week is first broken down to daily sales to align with the consumer calendar, in which the first week always starts on the first day of the month and ends on the seventh day of the month (i.e. a retailer year-week can be split across two consecutive calendar weeks). The mean daily sales is computed for each calendar week, which is the target response variable for the model fitting. In some embodiments, weeks with at least one day where the on-hand inventory reaches zero at the end of the day are considered OOS weeks and are marked for imputation. The covariates pertaining to the number of weeks before and after national holidays and events are aligned the same way, although capping is applied for the maximum number of surrounding weeks that can influence sales.

In some embodiments, after the preprocessing step, the GAM model is fit using the time series for the same item from all stores to generate a demand profile for each store in calendar weeks. The result from calendar weeks is re-assembled back into retailer year-week for replenishment and forecasting purposes.

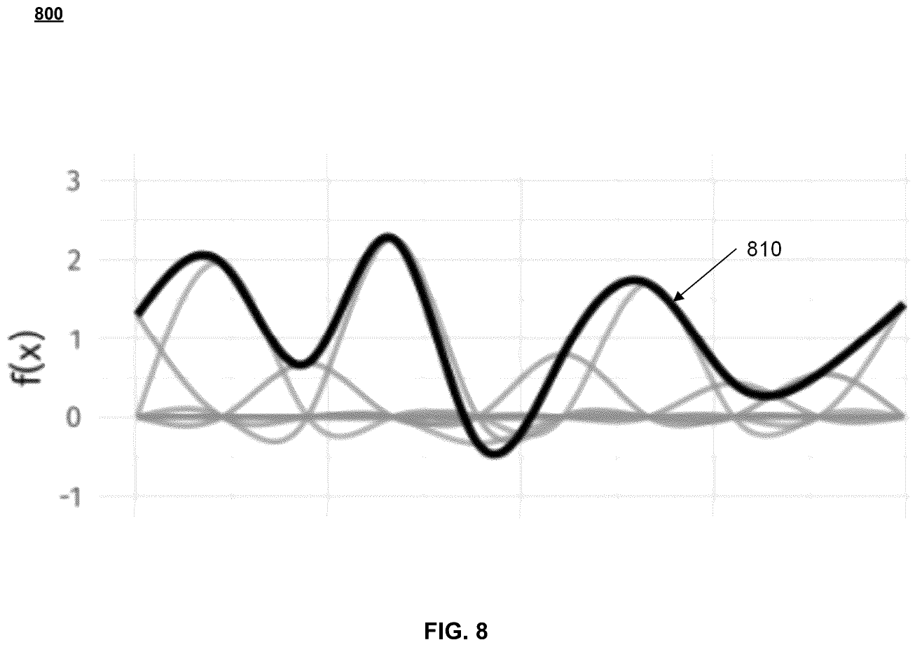

In some embodiments, a GAM's flexibility and interpretability comes from using splines and their basis functions to model non-linear relationships between the independent variables and the response variable. FIG. 8 illustrates an example for fitting a non-learning model based on covariates, in accordance with some embodiments of the present teaching. As shown in FIG. 8, a spline function 810 can be formed by a weighted sum of basis functions to adapt well to the underlying data.

In some embodiments, the GAM is a generalized linear model (GLM) in which the linear predictor is given by a user specified sum of smooth functions of the covariates. The GAM has the form:

g(E(yᵢ))=Aᵢθ+f₁(x₁ᵢ)+f₂(x₂ᵢ)+ . . .

where yᵢ is the response variable (often comes from an exponential family distribution), g(.) is a link function, Aᵢ is a row of the model matrix for any strictly parametric model components, θ is the corresponding parameter vector, and f₁ and f₂ are smooth functions of the covariates x₁ and x₂.

In some embodiments, the response variable is the mean daily sales quantity, where the covariates are the number of weeks to and after national events and holidays, payout weights (e.g. 50% on each of two payout days when there are two payout dates each month), geolocation of the store (latitude and longitude), week of month (WoM), month of year (MoY) and year. The WOM may take into consideration holidays like Thanksgiving which do not have a fixed date but will trigger corresponding sale spikes. The MoY may take into consideration seasonal events which are related to sale spikes. These covariates can help to fit a model to take into consideration cases when excluded OOS weeks fall into some sale spike time period. In some embodiments, the geolocation of a store also carries information about temperature and weather related to the store, into the model fitting process.

The model also includes their tensor product interactions. In some embodiments, the types of spline function used for the covariates may include identity, cyclic cubic regression splines, thin plate regression splines, two-dimensional Duchon splines, etc. For example, the identity function is used for number of weeks to and after national events and holidays; the cyclic cubic regression splines functions are used for WOM and MoY; the thin plate regression splines functions are used for year and payout weights; and the two-dimensional Duchon splines function is used for store latitude and longitude locations.

If any smooth functions were allowed in model fitting, then maximum likelihood estimation of such models would invariably result in complex overfitting estimates of f1 and f2. For this reason, the models are usually fit by penalized likelihood maximization, in which the model (negative log) likelihood is modified by the addition of a penalty for each smooth function that penalizes its “wiggliness”. In some embodiments, to control the trade-off between penalizing wiggliness and underfitting, each penalty is multiplied by an associated smoothing parameter. In some embodiments, the system uses the mgcv R package to estimate these parameters via fast restricted maximum likelihood (fREML). The mgcv implementation of the fitting functions, gam(.) and bam(.), represent the smooth functions using penalized regression splines, and use basis functions for these splines that are designed to be optimal given the number of basis functions desired. In some embodiments, the system uses the bam function from this package to fit the data set to take advantage of the numerical methods that are designed for large data sets and its lower memory footprint requirement.

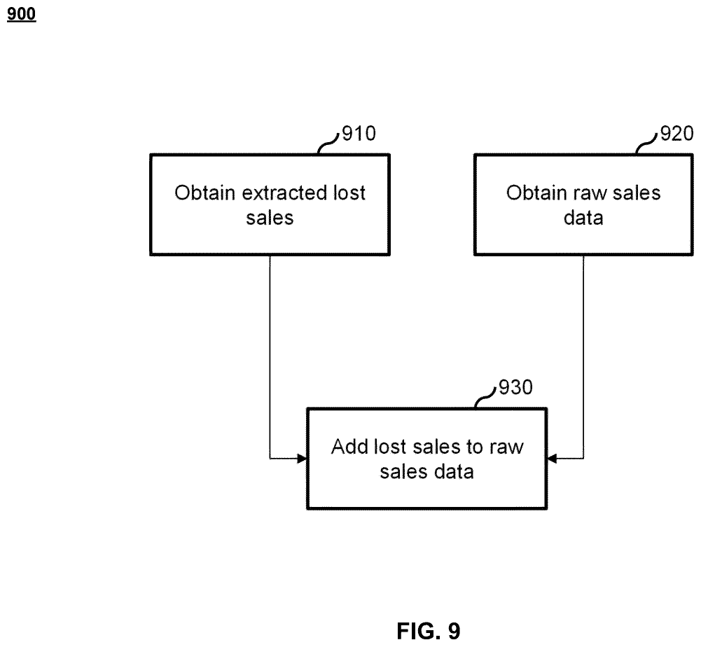

FIG. 9 illustrates a process 900 for generating unconstrained sale data, in accordance with some embodiments of the present teaching. In some embodiments, the process 900 can be carried out by one or more computing devices, such as the demand forecast computing device 102 and/or the cloud-based engine 121 of FIG. 1. In some embodiments, the process 900 is implemented to perform the operation 460 in FIG. 4, to augment raw sales data with estimated lost sales.

As shown in FIG. 9, the process 900 starts from operations 910 and 920 in parallel. At the operation 910, extracted lost sales data is obtained. At the operation 920, the raw sales data is obtained. Then at operation 930, the extracted lost sales for each OOS week is added to the actual sales in the raw sales data. This will generate unconstrained sale data of the item for the past time period, to be used as input data for unconstrained consumer demand prediction, or any other downstream forecasting algorithms. This will generate unconstrained forecasts even when faced with an extended OOS period, e.g. continuous multiple weeks that are all OOS.

As such, the disclosed method can estimate lost sales to transform any forecasting algorithm into one that produces unconstrained forecasts. This unique approach benefits from analyzing the collective consumer behavior across extensive store network of a retailer. Lacking on-shelf availability often leads to loss in customer faith and loyalty erosion. The effectiveness of the disclosed lost sales estimation has been validated in reducing OOS rate, improving forecast accuracy and on-shelf availability. In addition, the disclosed method renders any forecast manual lifting unnecessary during an extended OOS period. In some embodiments, the item price or item discount percentage can be added as a feature for the GAM model, and random effects in the GAM model can be included to account for store-specific effects.

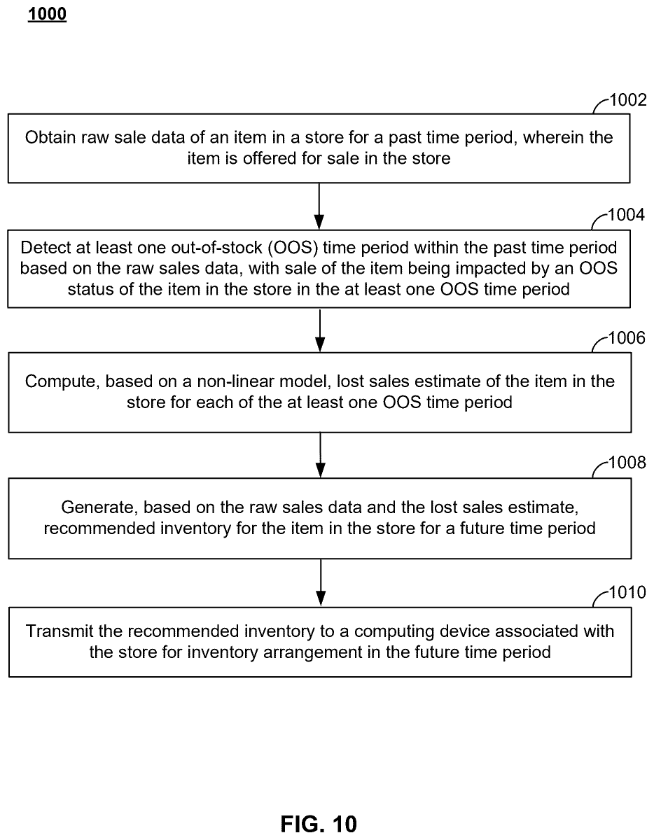

FIG. 10 is a flowchart illustrating an exemplary method 1000 for forecasting consumer demand based on accurate lost sales estimation, in accordance with some embodiments of the present teaching. In some embodiments, the method 1000 can be carried out by one or more computing devices, such as the demand forecast computing device 102 and/or the cloud-based engine 121 of FIG. 1. Beginning at operation 1002, raw sales data of an item in a store for a past time period is obtained. At operation 1004, at least one out-of-stock (OOS) time period is detected within the past time period based on the raw sales data. The sale of the item is impacted by an OOS status of the item in the store in the at least one OOS time period. At operation 1006, based on a non-linear model, lost sales estimate of the item in the store is computed for each of the at least one OOS time period. At operation 1008, based on the raw sales data and the lost sales estimate, recommended inventory is generated for the item in the store for a future time period. At operation 1010, the recommended inventory is transmitted to a computing device associated with the store for inventory arrangement in the future time period.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain raw sale data of an item in a store for a past time period,
wherein the item is offered for sale in the store,
detect at least one out-of-stock (OOS) time period within the past time period based on the raw sales data, wherein sale of the item is impacted by an OOS status of the item in the store in the at least one OOS time period,
compute, based on a non-linear model, lost sales estimate of the item in the store for each of the at least one OOS time period,
generate, based on the raw sales data and the lost sales estimate, recommended inventory for the item in the store for a future time period, and
transmit the recommended inventory to a computing device associated with the store for inventory arrangement in the future time period.

2. The system of claim 1, wherein:
the item is also offered for sale in at least one other store;
the store and the at least one other store include all physical stores associated with a same retailer; and
the lost sales estimate is computed based on sales data of the item in the at least one other store.

3. The system of claim 2, wherein:
the store is a physical store associated with a retailer; and
the at least one other store includes an online store associated with the retailer.

4. The system of claim 1, wherein the at least one OOS time period is detected based on:
obtaining an inventory status of the item in the store during the at least one OOS time period;
determining, based on the inventory status, whether the item has a first OOS status in the store during the at least one OOS time period based on a first method;
obtaining historical sales data of the item in the store;
determining, based on the inventory status and the historical sales data, whether the item has a second OOS status in the store during the at least one OOS time period based on a second method; and
detecting the at least one OOS time period in accordance with a determination that the item has at least one of the first OOS status or the second OOS status in the at least one OOS time period.

5. The system of claim 4, wherein determining whether the item has the first OOS status based on the first method comprises:
dividing the at least one OOS time period into one or more weeks;
for each day in the one or more weeks:
determining whether the store has any on-hand inventory of the item at end of the day,
determining the day as an OOS day for the item in accordance with a determination that the store has no on-hand inventory of the item at end of the day,
in accordance with a determination that the store has on-hand inventory of the item at end of the day,
computing an average one day of supply (DOS) for the item,
determining whether the on-hand inventory of the item is less than the average one DOS at end of the day,
determining the day as an in-stock (IS) day for the item in accordance with a determination that the on-hand inventory of the item is greater than or equal to the average one DOS at end of the day,
in accordance with a determination that the on-hand inventory of the item is less than the average one DOS at end of the day,
determining whether the store has any sale of the item during the day,
determining the day as an IS day for the item in accordance with a determination that the store has sale of the item during the day,
determining the day as an OOS day for the item in accordance with a determination that the store has no sale of the item during the day; and
for each week of the one or more weeks, determining the week as an OOS week in accordance with a determination that at least one day of the week is determined as an OOS day.

6. The system of claim 5, wherein determining whether the item has the second OOS status based on the second method comprises:
for each week in the one or more weeks:
generating, based on the inventory status and the historical sales data,
a saliency map of the item using a spectral residual method,
computing an in-stock moving average of the saliency map,
computing an anomaly score for the week based on the in-stock moving average,
determining whether the anomaly score is below a predetermined threshold,
determining the week as an OOS week for the item in accordance with a determination that the anomaly score is below the predetermined threshold,
determining the week as an IS week for the item in accordance with a determination that the anomaly score is higher than or equal to the predetermined threshold.

7. The system of claim 6, wherein the at least one OOS time period is detected based on:
for each week in the one or more weeks, determining the week as an OOS week for the item in accordance with a determination that the week is determined as an OOS week based on at least one of the first method or the second method.

8. The system of claim 2, wherein the lost sales estimate of the item is computed based on:
excluding, from the raw sales data, sales data of the item in the store in the at least one OOS time period to generate IS-only sales data of the item in the store for the past time period;
generating IS-only sales data of the item in the at least one other store for the past time period; and
combining the IS-only sales data of the item in the store with the IS-only sales data of the item in the at least one other store to generate combined sale data.

9. The system of claim 8, wherein the lost sales estimate of the item is computed further based on:
dividing the past time period into a plurality of consumer weeks, wherein a first day of a calendar month always aligns with a first day of one of the consumer weeks;
dividing the future time period into one or more retailer weeks, each of which starts at a fixed day of a calendar week;
dividing the combined sales data into daily sales data of the item; and
computing an average daily sales of the item for each of the consumer weeks.

10. The system of claim 9, wherein the average daily sales is computed based on:
generating, based on the combined sales data, covariates related to sale of the item in the store and the at least one other store for the non-linear model; and
performing a model fitting on the non-linear model to generate a fitted model, wherein the covariates are used as input to the non-linear model, and wherein the average daily sales is used as a target response variable of the non-linear model.

11. The system of claim 10, wherein:
the non-linear model is a generalized additive model (GAM); and
the covariates include data related to: week of month, month of year, year, assistance program payout proportion for each local state, latitude and longitude of each store, and a quantity of weeks to or after a predefined set of national and local events and holidays.

12. The system of claim 10, wherein:
the non-linear model is a machine learning model trained based on sales data from all stores.

13. The system of claim 10, wherein the lost sales estimate of the item is computed further based on:
imputing sales data of the item in the store for each OOS week in the at least one OOS time period using the fitted model, wherein each OOS week aligns with a retailer week;
re-assembling the imputed sales data to be aligned with the one or more retailer weeks; and
extracting lost sales estimate of the item for each OOS week in the at least one OOS time period by subtracting actual sales data from the imputed sales data in the OOS week.

14. The system of claim 13, wherein the recommended inventory is generated based on:
adding the extracted lost sales estimate for each OOS week in the at least one OOS time period to the raw sales data to generate unconstrained sales data of the item for the past time period;
forecasting, based on the unconstrained sales data, an unconstrained demand for the item in the store for the future time period; and
generating the recommended inventory based on the unconstrained demand forecast.

15. A computer-implemented method, comprising:
obtaining raw sale data of an item in a store for a past time period, wherein the item is offered for sale in the store;
detecting at least one out-of-stock (OOS) time period within the past time period based on the raw sales data, wherein sale of the item is impacted by an OOS status of the item in the store in the at least one OOS time period;
computing, based on a non-linear model, lost sales estimate of the item in the store for each of the at least one OOS time period;
generating, based on the raw sales data and the lost sales estimate, recommended inventory for the item in the store for a future time period; and
transmitting the recommended inventory to a computing device associated with the store for inventory arrangement in the future time period.

16. The computer-implemented method of claim 15, wherein detecting the at least one OOS time period comprises:
obtaining an inventory status of the item in the store during the at least one OOS time period;
determining, based on the inventory status, whether the item has a first OOS status in the store during the at least one OOS time period based on a first method;
obtaining historical sales data of the item in the store;
determining, based on the inventory status and the historical sales data, whether the item has a second OOS status in the store during the at least one OOS time period based on a second method; and
detecting the at least one OOS time period in accordance with a determination that the item has at least one of the first OOS status or the second OOS status in the at least one OOS time period.

17. The computer-implemented method of claim 16, wherein determining whether the item has the first OOS status based on the first method comprises:
dividing the at least one OOS time period into one or more weeks;
for each day in the one or more weeks:
determining whether the store has any on-hand inventory of the item at end of the day,
determining the day as an OOS day for the item in accordance with a determination that the store has no on-hand inventory of the item at end of the day,
in accordance with a determination that the store has on-hand inventory of the item at end of the day,
computing an average one day of supply (DOS) for the item,
determining whether the on-hand inventory of the item is less than the average one DOS at end of the day,
determining the day as an in-stock (IS) day for the item in accordance with a determination that the on-hand inventory of the item is greater than or equal to the average one DOS at end of the day,
in accordance with a determination that the on-hand inventory of the item is less than the average one DOS at end of the day,
determining whether the store has any sale of the item during the day,
determining the day as an IS day for the item in accordance with a determination that the store has sale of the item during the day,
determining the day as an OOS day for the item in accordance with a determination that the store has no sale of the item during the day; and
for each week of the one or more weeks, determining the week as an OOS week in accordance with a determination that at least one day of the week is determined as an OOS day.

18. The computer-implemented method of claim 17, wherein determining whether the item has the second OOS status based on the second method comprises:
for each week in the one or more weeks:
generating, based on the inventory status and the historical sales data,
a saliency map of the item using a spectral residual method,
computing an in-stock moving average of the saliency map,
computing an anomaly score for the week based on the in-stock moving average,
determining whether the anomaly score is below a predetermined threshold,
determining the week as an OOS week for the item in accordance with a determination that the anomaly score is below the predetermined threshold,
determining the week as an IS week for the item in accordance with a determination that the anomaly score is higher than or equal to the predetermined threshold.

19. The computer-implemented method of claim 15, wherein computing the lost sales data of the item comprises:
excluding, from the raw sales data, sales data of the item in the store in the at least one OOS time period to generate IS-only sales data of the item in the store for the past time period;
generating IS-only sales data of the item in at least one other store for the past time period, wherein the item is also offered for sale in the at least one other store;
combining the IS-only sales data of the item in the store with the IS-only sales data of the item in the at least one other store to generate combined sales data;
dividing the past time period into a plurality of consumer weeks, wherein a first day of a calendar month always aligns with a first day of one of the consumer weeks;
dividing the future time period into one or more retailer weeks, each of which starts at a fixed day of a calendar week;
dividing the combined sales data into daily sales data of the item;
generating, based on the combined sales data, covariates related to sale of the item in the store and the at least one other store for the non-linear model; and
performing a model fitting on the non-linear model to generate a fitted model, wherein the covariates are used as input to the non-linear model, and wherein an average daily sales of the item for each of the consumer weeks is used as a target response variable of the non-linear model.

20. A non-transitory computer readable medium having instructions stored thereon, wherein the instructions, when executed by at least one processor, cause at least one device to perform operations comprising:
obtaining raw sales data of an item in a store for a past time period, wherein the item is offered for sale in the store;
detecting at least one out-of-stock (OOS) time period within the past time period based on the raw sales data, wherein sale of the item is impacted by an OOS status of the item in the store in the at least one OOS time period;
computing, based on a non-linear model, lost sales estimate of the item in the store for each of the at least one OOS time period;
generating, based on the raw sales data and the lost sales estimate, recommended inventory for the item in the store for a future time period; and
transmitting the recommended inventory to a computing device associated with the store for inventory arrangement in the future time period.
